(19) United States
(12) Patent Application Publication
(10) Pub. No.: US 2015/0011158 A1
(43) Pub. Date: Jan. 8, 2015

(54) APPARATUS, METHOD, AND COMPUTER PROGRAM FOR A MOBILE RELAY STATION TRANSCEIVER, SYSTEM, AND MEANS FOR MASS TRANSPORTATION

(71) Applicants: Qinglin Luo, Shanghai (CN); Yuwen Pan, Shanghai (CN); Guodong Li, Shanghai (CN)

(72) Inventors: Qinglin Luo, Shanghai (CN); Yuwen Pan, Shanghai (CN); Guodong Li, Shanghai (CN)

(73) Assignee: ALCATEL LUCENT, Boulogne Billancourt (FR)

(21) Appl. No.: 14/376,956

(22) PCT Filed: Feb. 6, 2012
(86) PCT No.: PCT/CN2012/070914

§ 371 Date: Aug. 6, 2014

(51) Int. Cl. H04W 16/26

(52) U.S. Cl. CPC H04W 16/26; H04W 84/047
USPC 455/11.1

(57) ABSTRACT

Embodiments provide an apparatus, a method, and a computer program for a mobile relay station transceiver. Embodiments may further provide a system and means for mass transportation. An apparatus (10) for a mobile relay station transceiver (100) in a mobile communication system (500) comprises a donor interface (12) operable to communicate with a donor base station transceiver (300) and an air interface (14) operable to communicate with a mobile transceiver (400). The apparatus (10) further comprises a relay interface (16) operable to communicate with another relay station transceiver (200).

Embodiments of the present invention relate to mobile communication networks, more particularly but not exclusively to mobile relaying networks.

### BACKGROUND

Demands for higher data rates for mobile services are steadily increasing. At the same time modern mobile communication systems as 3rd generation systems (3G as abbreviation) and 4th generation systems (4G as abbreviation) provide enhanced technologies which enable higher spectral efficiencies and allow for higher data rates and cell capacities. As operators are seeking to extend the coverage of their networks, relaying concepts become more and more sophisticated.

In the 3rd Generation Partnership Project (3GPP) as international standardization body, relay architectures for Evolved-Universal Terrestrial Radio Access (E-UTRA) have been discussed and results collected in Technical Recommendation (TR) 36.806. These new architectures are likely to be established in future Long Term Evolution (LTE) and LTE-Advanced (LTE-A) networks.

In relaying architectures a relay station transceiver may extend the coverage of a base station transceiver. Basic concepts use a relay station transceiver, which receives signals from a base station transceiver and forwards them to mobile transceivers, and vice versa, in an amplify-and-forward fashion. The radio signals from the base station transceiver are received, amplified and transmitted to the mobile transceiver by the relay station transceiver and vice versa, respectively. In such a scenario the relay station may not even be identified as such by a mobile transceiver. In other concepts, the relay station transceiver may correspond to a base station transceiver, which is connected to another base station transceiver, the so-called donor base station transceiver, via a radio interface and provides radio services as a base station to the mobile transceiver station.

### SUMMARY

Embodiments are based on the finding that there are scenarios where the relay station can be mobile, e.g. in means of mass transportation such as a train, a bus, a car, on a boat, etc. Moreover, it is a finding that in such scenarios an improved mobility management may be desirable. It is a further finding that current architectures, e.g. 3GPP LTE Release 10 (R10) relay architecture, cf. Technical Report (TR) 36.806 v9.00, focuses on fixed relaying scenarios, i.e. a mobility scenario involving handover of a mobile transceiver between a relay station and a base station, such as an evolved NodeB (eNB), is considered. In such a scenario, a link between two relay stations or a link to other network entities (relay and eNB), such as the X2 link, uses the air interface, such as a Un interface, between a relay station and the respective Donor eNB (DeNB).

Moreover, for a Mobile Relay (MR), which can be targeted at a high speed train scenario, a Un dependent X2 interface can be inefficient because the Un interface can be subject to frequent handover due to the MR's high mobility, e.g. when imagining a train moving at high speed through a network. The X2 interface may need to be frequently reestablished, it may cause significant signaling overhead on the Un interface, and it may decrease backhaul bandwidth efficiency. The latency of the conventional X2 interface between mobile relays is an aggregation of the latency of two Un interfaces and the inter-eNB X2 (cf alternative 2 of TR 36.806 v9.00) or two MR Si interfaces (cf. alternative 1 of TR 36.806 v9.00). Embodiments are therefore based on the finding, that conventional inter-RN X2 may not be able to support efficient cooperation between relays with strict latency requirements. Moreover, it is a finding that there is a low possibility that a UE moves out of a train in high speed, thus it may not be essential to support X2 handover between MR and eNB, which may be the major targeted scenario of the conventional X2 interface.

It is a further finding that routing an information exchange between relays through the backhaul (Un interface) can be disadvantageous. For a mobile relay the unreliable nature of the link to the DeNB due to high mobility and the highly varying transmission environment may make it difficult to rely on this link for handover or inter-relay cooperation. Embodiments may therefore make use of a direct link between mobile relays, which will also be referred to as mrX2 in case of an X2 link. This link may support both inter-relay X2 handover and cooperative backhaul.

Embodiments therefore provide an apparatus for a mobile relay station transceiver in a mobile communication system, i.e. embodiments may provide said apparatus to be operated by or included in a mobile relay station transceiver. In the following, the apparatus will also be referred to as mobile relay station transceiver apparatus. The mobile communication system may, for example, correspond to one of the mobile communication systems standardized by 3GPP, as Universal Terrestrial Radio Access Network (UTRAN) or Evolved UTRAN (E-UTRAN), Long Term Evolution (LTE) or LTE-Advanced (LTE-A), or mobile communication systems with different standards, e.g. Worldwide Interoperability for Microwave Access (WIMAX) IEEE 802.16 or Wireless Local Area Network (WLAN) IEEE 802.11, generally any system based on Orthogonal Frequency Division Multiple Access (OFDMA), Code Division Multiple Access (CDMA), etc. In the following the terms mobile communication system and mobile communication network are used synonymously.

In embodiments, the mobile relay station transceiver may be implemented in a transceiver of the mobile or wireless end of one of the above networks. From a base station's perspective, e.g. an eNB, of the mobile communication system, the mobile relay station transceiver may behave similar to mobile transceiver such as a smartphone, a cell phone, a User Equipment (UE), a laptop, a notebook, a personal computer, a Personal Digital Assistant (PDA), an Universal Serial Bus (USB) -stick, a car, etc. A mobile transceiver may also be referred to as UE in line with the 3GPP terminology. From a mobile transceiver's perspective the relay station transceiver may behave like a base station transceiver, as it can be located in the fixed or stationary part of the network or system. A base station transceiver may correspond to a remote radio head, an access point, a macro-cell, a small-cell, a micro-cell, a femto-cell, etc. A base station transceiver can be a wireless interface of a wired network, which enables transmission of radio signals to a user equipment or mobile transceiver. Such a radio signal may comply with radio signals as, for example, standardized by 3GPP or, generally, in line with one or more of the above listed systems. Thus, a base station transceiver may correspond to a NodeB, an eNodeB, an access point, etc.

Hence, the relay station transceiver can be operable to relay control and payload data between a mobile transceiver and a donor base station transceiver. The relay station transceiver apparatus comprises a donor interface operable to communicate with a donor base station transceiver. The donor interface can be operable to enable wireless communication in line with one of the above listed communication systems between the relay station transceiver and the donor base station transceiver. The relay station transceiver apparatus further comprises an air interface operable to communicate with the mobile transceiver. In other words, the air interface can be operable to wirelessly communicate with the mobile transceiver in line with one of the above listed mobile communication systems. Furthermore, the relay station transceiver apparatus comprises a relay interface operable to communicate with another relay station transceiver. The other relay station transceiver may also be mobile with respect to the donor base station transceiver. In some embodiments the relay station transceiver and the other relay station transceiver are fixed or stationary with respect to each other, but mobile with respect to the donor base station transceiver.

In embodiments the relay station transceiver may comprise a transmitter, or means for transmitting, for transmitting radio signals to the mobile transceiver in line with one of the above communication systems. Moreover, the transmitter or the means for transmitting can be operable to transmit radio signals to the donor base station transceiver. Furthermore, the relay station transceiver may comprise a receiver, or means for receiving, in line with one of the above communication systems. In other words, the receiver can be operable to receive radio signals from the mobile transceiver and the donor base station transceiver in line with one of the above communication systems.

In embodiments the mobile relay station apparatus can further comprise means for controlling the mobility of the mobile transceiver. In other words, the mobile relay station transceiver apparatus may comprise a controller, such as a processor, a micro-processor, a digital signal processor, etc., to control the mobility of the mobile transceiver. The mobility of the mobile transceiver relates to movements of the mobile transceiver relative to a coverage area of the mobile relay station transceiver. In other words, the mobile transceiver can move out of the coverage area, into the coverage area, respectively, of the mobile relay station transceiver. If the mobile transceiver has an active connection, i.e. if the mobile transceiver is actively exchanging data with the mobile relay station transceiver, then the means for controlling is operable to control a handover to or from an adjacent mobile relay station transceiver. If the mobile transceiver is in an idle mode, i.e. it has not an active data transmission, then the means for controlling may be operable to control a cell or tracking area update procedure of the mobile transceiver. The cell or tracking area update procedure may be necessary, in order to be able to page the mobile transceiver in case of an incoming call. The means for controlling can be operable to control the relay interface such that a control signal relating to a mobility of the mobile transceiver between the mobile relay station transceiver and the other relay station transceiver is exchanged using the relay interface. According to what was already stated above, the control signal may comprise any signaling relating to a handover procedure or cell or tracking area update procedure. In embodiments, such mobility related control signals can be exchanged using the relay interface between the two relay station transceivers. In embodiments, signaling of such control signals using an air interface between the mobile relay transceiver apparatus and the donor base station transceiver can be reduced, in some embodiments it may even be avoided completely.

That is to say, in embodiments the air interface of the mobile relay station transceiver may generate a first coverage area for the mobile transceiver and the other relay station transceiver may generate the second coverage area for the mobile transceiver. The first coverage area and the second coverage area can be adjacent to each other, such that the mobile transceiver can move from the coverage area of the mobile relay station transceiver to the coverage area of the other relay station transceiver and vice versa. The relay interface can be operable to communicate with the other relay station transceiver when the mobile transceiver moves between the first and second coverage areas. Such a communication between the mobile relay station transceiver and the other relay station transceiver may include control signaling relating to handover and tracking area update signaling, as well as data signals. For example, when the mobile transceiver hands over from one coverage area to the other, the relay interface can be used to transfer a remaining buffer status of data, which had not been sent yet.

In some embodiments the relay interface between the mobile relay transceiver and the other relay transceiver station can be a wireless interface. For example, the relay interface can be operable to enable communication in line with one of the above communication systems. In other embodiments, the relay interface may correspond to a wired interface, where any wired connection may be used to enable the inter-relay station transceiver communication, e.g. an optical fiber can be used. Moreover, in some embodiments the mobile relay station transceiver apparatus can be operable for relaying data between the mobile transceiver and the mobile communication system using the donor interface or using the relay interface. In such a scenario, the mobile relay station transceiver and the other relay station transceiver may be installed, for example, in a train. Potentially, both relay station transceivers may have a wireless connection to a donor base station transceiver. In such a situation, multiple scenarios are conceivable, as, for example, each relay station transceiver has a different donor base station transceiver or both relay station transceivers are connected to the same donor base station transceiver. Anyway, in such a scenario the two relay station transceivers may have different connections, i.e. independent connections to the one or two donor base station transceivers. Embodiments may take advantage of such a situation by being able to choose or combine the donor interface and/or the relay interface and therewith the donor interface of the other relay station transceiver for communicating the data. In some embodiments diversity gains may be achieved by making use of the multiple connections to the donor base station transceiver. That is to say, since there are multiple connections to the donor base station transceivers, which can be independent, and since one of these connections can be selected, the overall probability of a radio link failure on a donor interface can be reduced.

In further embodiments the mobile relay station transceiver may further comprise means for controlling, i.e. a controller, processor, or microprocessor, etc., which is operable to control the relay interface for relaying the data based on the quality of a radio link on the donor interface and based on the quality of a radio link between the other relay station transceiver and another donor base station transceiver of the other relay station transceiver. This brief description of some embodiments already shows that multiple options arise, and multiple combining methods may be applied. For example, two radio links can be established between the two relay station transceivers, which are interconnected using the relay interface. Some of the combining options are selection combining, by selecting one of the two links, maximum ratio combining, by combining the same data which is received through both of the radio links. Other advanced processing options arise, which can be taken advantage of in further embodiments, as, for example, receive diversity, transmit diversity, macro combining, etc.

Moreover, in embodiments the mobile relay station apparatus can be operable to exchange load information, link status information, or configuration update information with the other relay station transceiver using the relay interface. In other words, load information may be exchanged between the two relay station transceivers. Therewith, both relay station transceivers can be made aware of the load situation at the neighbor relay station receiver, enabling load coordination. Moreover, the link status information can comprise quality information of a link between the mobile relay station transceiver and the donor base station transceiver, such that the above mechanism of cooperative transmission can be enabled. In another embodiment link status information may be provided as a quality measure on the link between the mobile relay station transceiver and a mobile transceiver, for example, for handover purposes. Moreover, configuration update information may be exchanged, which may comprise any configuration updates on the radio link to the donor base station transceiver or any mobile transceivers.

In yet another embodiment information on measurement reports of a backhaul link between the mobile relay station transceiver and the donor base station transceiver or information on a transport network layer association or an Internet Protocol (IP) routing with the other relay station transceiver using the relay interface may be exchanged. The information on measurement reports of the backhaul link may correspond to the measurement reports, which the mobile relay station transceiver carries out in order to enable mobility and handover within the mobile communications network. In other words, for the relay station transceiver to move from one donor base station transceiver to the next donor base station transceiver handover procedures are necessary, which are based on respective measurements, for example, measurements on reference signals of the donor base station transceivers. These measurements may also be used to obtain information on the quality of the respective radio links, which can be exchanged between embodiments of the relay station transceivers. Based on these measurements or measurement reports load balancing or the above-mentioned diversity concepts may be established. Furthermore, in embodiments information on a transport network layer association or an IP routing can be exchanged with the other relay station transceiver, for the other relay station transceiver to use the relay interface and the donor interface to route its data, for example, in case its own radio link to its own donor base station transceiver is worse than the radio link through the donor interface.

In further embodiments the relay interface can be used to exchange information for load balancing and interference coordination between the mobile relay station transceiver and the other relay station transceiver. For example, information on radio resources or radio resource utilization can be exchanged. That is to say, the mobile relay station transceiver may inform the other relay station transceiver on certain radio resources, on which interference created by the other relay station transceiver is critical. The other relay station transceiver may take this information into account and reduce its transmission power on the critical radio resources. Obviously, this mechanism may be carried out the other way around. In such an embodiment the other relay station transceiver may inform the mobile relay station transceiver on radio resources, on which the other relay station transceiver experienced critical interference. Having received this information through the relay interface, the mobile relay station transceiver may reduce its transmission power on the critical radio resources and thus reduce the interference experienced by the other relay station transceiver. This is just one example on how the relay interface can be used to carry out load balancing or interference coordination. Moreover, in embodiments the relay interface can be used to exchange information on a request, an acknowledgment, error signaling on load information status information, or configuration update information with the other relay station transceiver. That is to say, in order to coordinate the interference or a cooperative transmission or cooperation as such, certain requests, acknowledgments, error signaling, status information, etc. may be exchanged using the relay interface. In other words, the mobile relay station transceiver can be operable to establish backhaul cooperation between the donor interface and another donor interface of the other relay station transceiver. This embodiment corresponds to one of the above embodiments, in which basically at least two radio links are used to take advantage of diversity concepts, combining concepts, etc.

Embodiments further provide a system comprising a first mobile relay station transceiver with the apparatus according to the above description and comprising a second mobile relay station transceiver with another apparatus according to the above description. The first and the second mobile relay station transceivers are coupled through their relay interfaces for communicating. In some embodiments, the system can be installed in means of mass transportation, such as a train, a bus, a ship, a plane, etc. Therefore embodiments may, for example, also provide a train wagon comprising the system.

Moreover, embodiments provide a method for a mobile relay station transceiver in a mobile communication system. The method comprises a step of communicating with a donor base station transceiver using a donor interface and a step of communicating with the mobile transceiver using an air interface. The method further comprises a step of communicating with another relay station transceiver using the relay interface.

Embodiments may further provide a computer program having a program code for performing one of the above methods, when the computer program is executed on a computer, processor, or respective hardware.

### BRIEF DESCRIPTION OF THE FIGURES

Some other features or aspects will be described using the following non-limiting embodiments of apparatuses and/or methods and/or computer programs by way of example only, and with reference to the accompanying figures, in which

FIG. 1 shows an embodiment of an apparatus for a mobile relay station transceiver;

FIG. 2 illustrates different architectures of a relaying network;

FIG. 3 illustrates protocol stacks for different architectures;

FIG. 4 illustrates an embodiment in a train with two relay stations connected to the same donor base station;

FIG. 5 illustrates the embodiment in a train with the two relay stations connected to different donor base stations;

FIG. 6 shows an illustration of multiple mobility scenarios in a network;

FIG. 7 shows protocol stacks for an inter-mobile relay communication in embodiments; and

FIG. 8 shows a block diagram of a flow chart of an embodiment of a method for a mobile relay station transceiver.

### DESCRIPTION OF SOME EMBODIMENTS

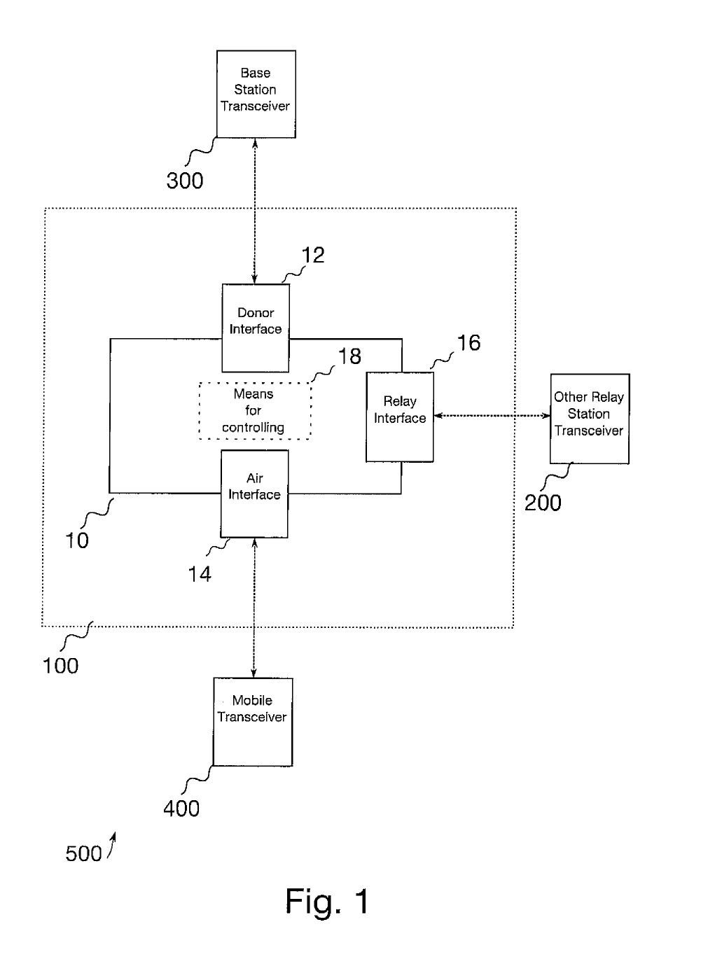

In the following description some components will be displayed in multiple FIGS. carrying the same reference signs, but may not be described multiple times in detail. A detailed description of a component may then apply to that component for all its occurrences. FIG. 1 shows an embodiment of an apparatus 10 for a mobile relay station transceiver 100 in a mobile communication system 500. The mobile relay station transceiver 100 is shown in dotted lines, as it is optional. Embodiments may provide a mobile relay station transceiver 100 comprising the mobile relay station transceiver apparatus 10. In line with FIG. 1 the apparatus 10 comprises a donor interface 12 operable to communicate with a donor base station transceiver 300 and an air interface 14 operable to communicate with a mobile transceiver 400. The potential communication is indicated by double sided dashed arrows. The apparatus 10 further comprises a relay interface 16 operable to communicate with another relay station transceiver 200.

In the embodiment shown in FIG. 1, the apparatus 10 further comprises the optional means for controlling 18 the mobility of the mobile transceiver 400. The means for controlling 18 is operable to control the relay interface 16 such that a control signal relating to the mobility of the mobile transceiver 400 between the mobile relay station transceiver 100 and the other relay station transceiver 200 is exchanged using the relay interface 16.

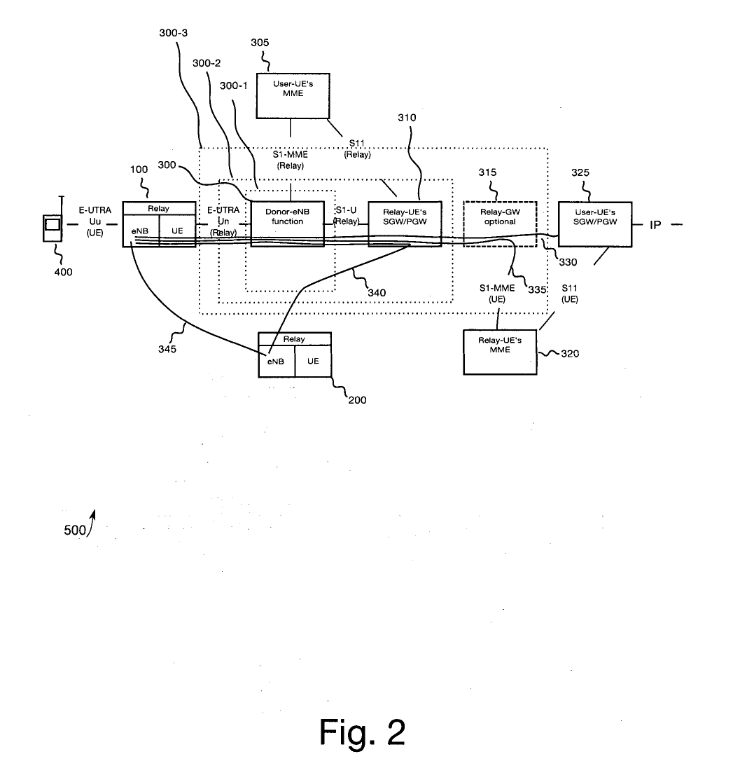

FIG. 2 illustrates different architectures of a relaying network, which is embodied as an LTE network 500. FIG. 2 shows the mobile transceiver 400, which is connected to the relay station 100 through the E-UTRA Uu interface, i.e. the E-UTRA air interface. As indicated in FIG. 2 the relay station 100 acts as an eNB towards the UE and it acts as a UE towards the donor eNB 300. The donor eNB 300 is connected to a User-UE's Mobility

Management Entity (MME) 305 through a S1-MME interface. Moreover, the donor eNB 300 is connected to a Relay-UE's S1 GateWay (SGW) and Packet data network GateWay (PGW) 310 through the S1-User plane (S1-U) interface. The SGW/PGW 310 is further connected to the User-UE'S MME 305 through the S11 interface. FIG. 1 further shows an optional Relay-GateWay (GW) 315, which is connected to a Relay-UE's MME 320 using an S1-MME. The architecture further shows a User-UE'S SGW/PGW 325, which is connected to the Relay-UE's MME 320 through an S11 interface. The User-UE's SGW/PGW 325 can then be connected to a Packet Data Network (PDN) using an IP interface.

FIG. 2 further illustrates two data paths through the network 500 and its components showing how the user-plane 330 and the control-plane 335 data of the relay station 100 are established connecting to the User-UE's SGW/PGW 325 and the Relay-UE's MME 320. Moreover, FIG. 2 shows another relay station transceiver 200 and indicates the conventional path 340 for the X2 interface between the relay station 100 and the other relay station 200. Moreover, FIG. 2 shows an X2 path 345 according to one embodiment, which directly connects the relay station 100 and the other relay station 200. Moreover, FIG. 2 indicates three dotted boxes 300-1, 300-2, 300-3, which show different architectural alternatives. The three alternatives 300-1, 300-2, and 300-3 differ in the functionalities, which are assigned to the donor eNB 300. The dotted boxes therefore indicate the donor eNB 300 according to three different architectures, cf TR 36.806 v9.0.0.

For a mobile relay 100, both the UE 400 and the Relay's 100 (as a Relay-UE) mobility need to be considered. In Alternative 2, Relay-UE's P/S-GW and Home-eNB GW (HeNB) like functionality can be relocated once the Relay-UE 100 moves to another DeNB 360, which would cause large delay and potential frequent handover failure. Alternative 1 can deal with these issues but may have some drawbacks. One drawback may be that it requires the update of legacy MME. Another drawback is that the Un interface may be congested by multiple X2 links due to multiple UEs' X2 handover to different target eNBs/Relays.

In case multiple relays are deployed on one train for either alternatives, X2 handover between mobile relays can be offloaded from the Un interface 12 to a direct link 16 between mobile relays 100, 200 (not through the Un interface 12) so as to increase backhaul efficiency and handover success rate. The functionality of the direct link 16 is similar to that of the normal inter-eNB X2 link but can be enhanced with features supporting cooperative mobile relay.

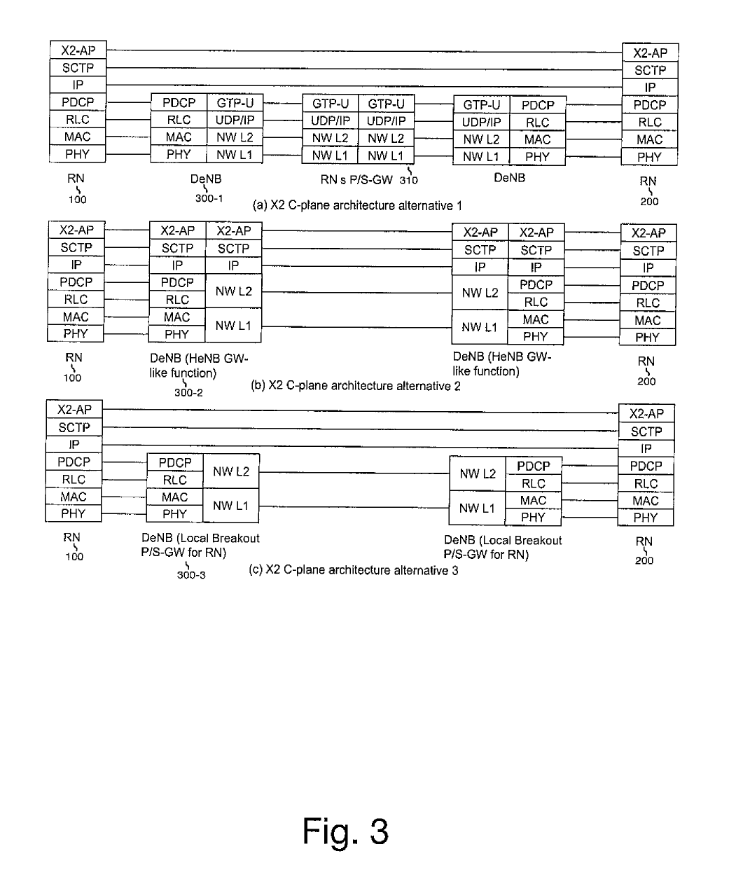

FIG. 3 illustrates the three different protocol stacks for the X2 interface according to the three conventional alternatives 300-1, 300-2, and 300-3 of FIG. 2, of. TR 36.806 v9.0.0. Alternative 1 according to 300-1 is shown at the top, alternative 2 according to 300-2 is shown in the middle, and alternative 3 according to 300-3 is shown at the bottom. All three view graphs of FIG. 3 show the relay station's 100 protocol stack on the very left hand side and the other relay station's 200 protocol stack on the very right hand side. The relay station's 100 protocol stack has a counterpart at the respective DeNB 300, correspondingly the other relay station's 200 protocol stack has a counterpart at the other DeNB, which is not shown in FIG. 2 but is considered here for completeness of the protocol stacks. In other words, it is assumed that the relay station 100 and the other relay station 200 are served by two different DeNBs. According to alternative 1 there is the Relay-UE' s SGW/PGW 310 between the two DeNBs.

The protocol stacks involve the following protocols, details of which can be found in the according specifications, e.g. the 3GPP Technical Specifications (TS): the X2-Application Part (X2-AP), the Streaming Control Transport Protocol (SCTP), the Internet Protocol (IP), the Packet Data Convergence Protocol (PDCP), the Radio Link Control (RLC), the Medium Access Control (MAC), the Physical layer (PHY), the General Packet Radio Service (GPRS) Tunneling Protocol-User plane (GTP-U), the Universal Datagram Protocol (UDP), a Network Layer 2 Protocol (NW L2) and a Network Layer 1 Protocol (NW L1).

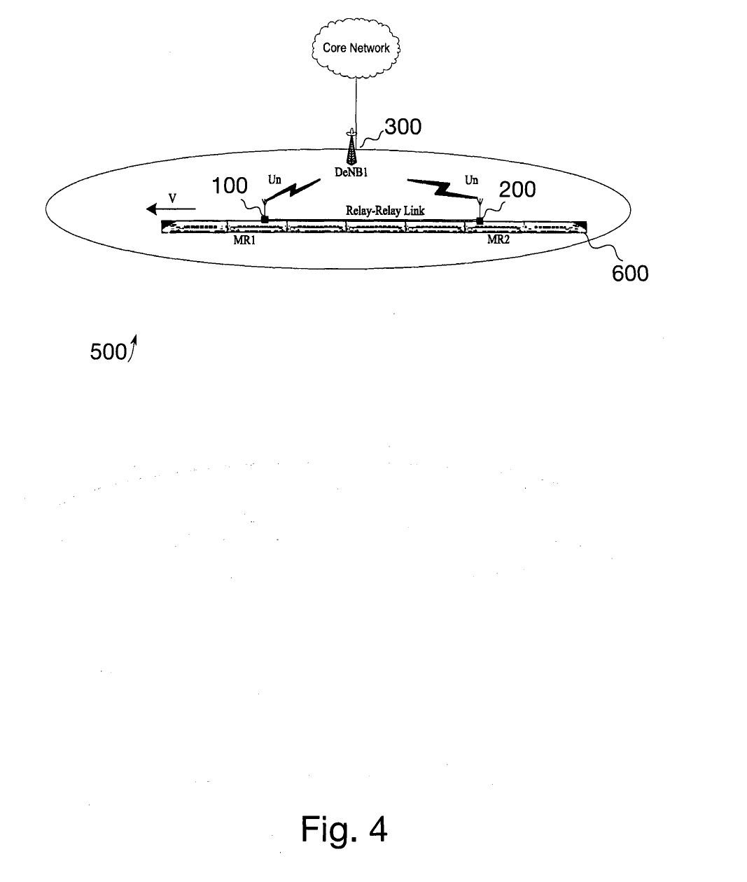

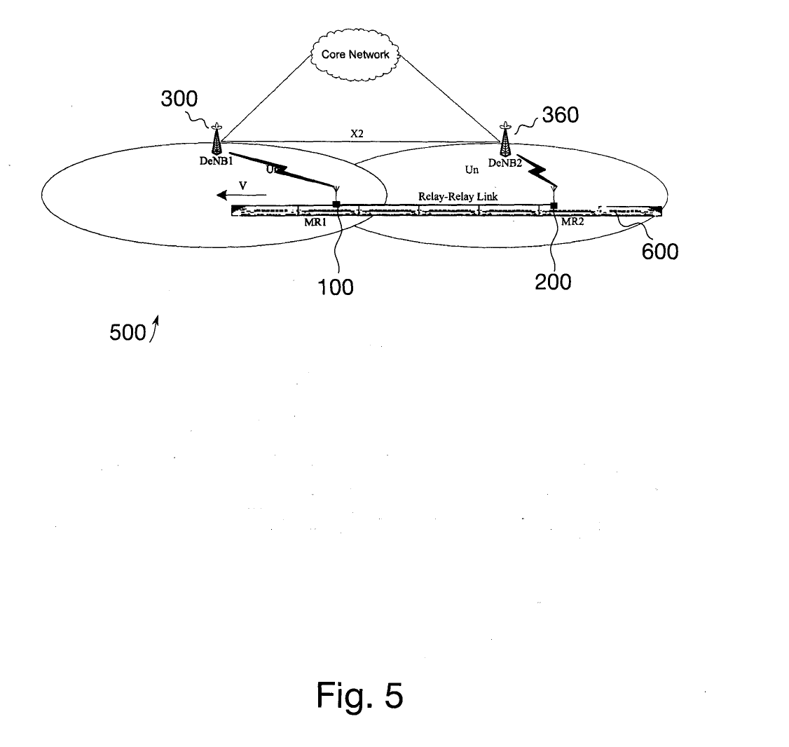

FIGS. 4 and 5 illustrate an embodiment in a train 600 as a means for mass transportation. Both figures show a communication system 500 with an embodiment of the mobile relay station transceiver 100 and with another embodiment as another mobile relay station transceiver 200. In other words, the figures show an embodiment of a system comprising a first mobile relay station transceiver 100 (which is also referred to as Mobile Relay 1 (MR1)) with an apparatus 10 according to the above description and comprising a second mobile relay station transceiver 200 (MR2) with another apparatus 10 according to the above description. The first and the second mobile relay station transceivers 100, 200 are coupled through their relay interfaces 16 for communicating. The system is implemented in means of mass transportation, i.e. in a train 600 according to FIGS. 4 and 5. Moreover, FIG. 4 shows the donor base station transceiver 300, which is also referred to as DeNB1, FIG. 5 further shows another donor base station transceiver 360, which is also referred to as DeNB2, DeNB1 and DeNB2 connect to the Core Network (CN) of the communication system 500.

As can be seen from FIG. 4 both mobile relays 100, 200, MR1 and MR2, may be connected to the same donor base station transceiver 300, DeNB1. As the train 600 moves through the cellular network, the situation of FIG. 5 may occur as well, that is to say the mobile relays 100, 200 may as well be connected to different DeNBs 300, 360, namely DeNB1 and DeNB2. FIGS. 4 and 5 illustrate application scenarios of multiple MRs on a high speed train. In this scenario, multiple mobile relays 100, 200 are deployed on one train, They can communicate with their DeNB independently. Thus there are multiple backhaul links available.

The bandwidth and reliability of the backhaul (Un interface 12) is critical to the performance of mobile relay 100. Any backhaul link failure would cause call drops of all UEs attached. Particularly for the high speed train scenario, the backhaul is vulnerable due to highly variant wireless channels, frequent handover and severe Doppler shift.

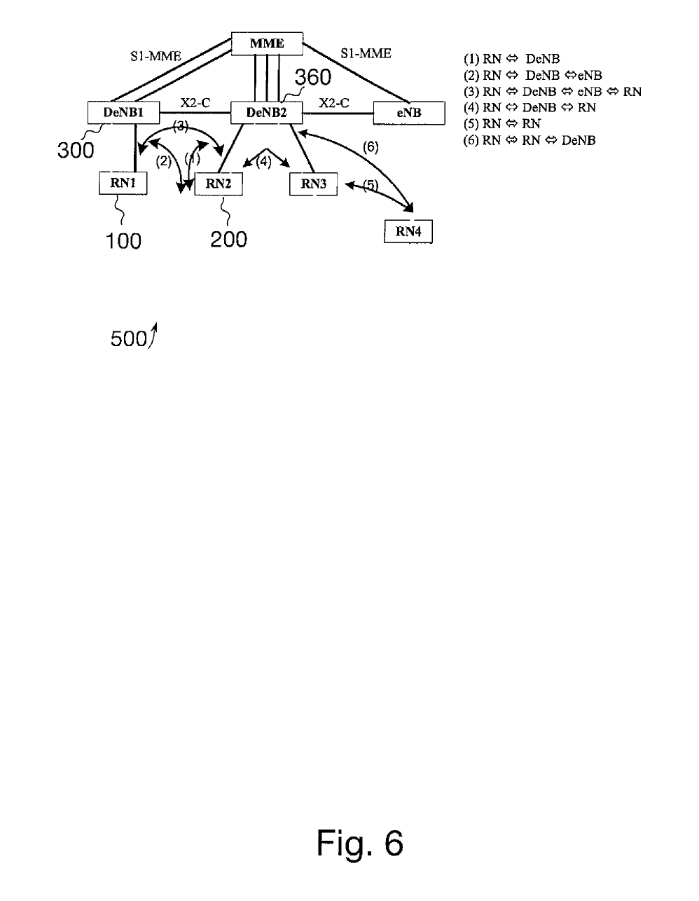

FIG. 6 shows an overview of the mobility scenarios in a network with mobile relays. FIG. 6 shows four Relay Nodes (RN1, RN2, RN3, RN4) and two Donor eNB (DeNB1, DeNB2) together with a eNB, where the eNBs are interconnected using the X2-Control plane (X2-C) and individually connect to MME using the S1-MME. The RNs are connected to the DeNB using X2 and S1-MME, i.e. FIG. 6 illustrates X2 tunneling via the respective DeNB. Moreover, RN1 is connected to DeNB1, RN2 and RN3 are connected to DeNB2, and RN4 is connected to RN3 via X2. A list of six mobility scenarios is given on the right hand side of FIG. 6, the respective scenarios are indicated by correspondingly labeled double sided arrows, pointing towards the components the respective mobility scenario refers to.

In fixed relay, a macro coverage hole is the main application scenario, thus UE mobility scenario (1) (between RN and its DeNB) is of the highest importance. The scenario of a high-speed 600 vehicle with enclosed shell can be considered as a main scenario for a mobile relay. In such an environment, a UE at high speed would usually be not able to move outside the train 600. The mobility between relay 100 and eNB may only happen at a station. It is reasonable to assume that the UE mobility management for the station has no significant difference from that for the conventional fixed relay since the train 600 is no longer moving.

Hence, either there is little UE mobility issue for high speed train 600 if a single relay is deployed for the whole train, or a more likely scenario is that a UE moves between relay nodes 100, 200 deployed on the same train 600. Considering the potential benefit of multiple relays 100, 200, the UE mobility scenario should be considered as shown in FIG. 6, e.g., scenarios (4) (between RNs sharing the DeNB) and (3) (between RNs not sharing the DeNB) are interesting mobility scenarios for MR UEs. Based on above analysis, X2 handover between MR and eNB is unlikely to happen in a mobile relay scenario using the high-speed train. Only inter-relay X2 handover is possible when assuming that no handover occurs to a eNB outside the train for as long as the train is moving. Thus, the X2 interface between MR and eNB may not be used as often as the inter-relay X2 interface. Embodiments therefore provide a direct link between MRs on the same train, which may suffice the support of MR UE's mobility.

In other words, in the embodiment of the apparatus 10 of the mobile transceiver station 100 the air interface 12 generates a first coverage area for the mobile transceiver 400, which is located in the train 600 in FIGS. 4 and 5. The other relay station transceiver 200 generates a second coverage area for the mobile transceiver 400. Moreover, in the embodiment the first coverage area and the second coverage area are adjacent to each other. The relay interface 16 is operable to communicate with the other relay station transceiver 200 when the mobile transceiver 400 moves between the first and the second coverage areas. That is to say, handover related signaling for a mobile transceiver 400, which moves in the train 600 between the coverage areas of the mobile relay station 100 and the other mobile relay station transceiver 200 can be carried out using the relay interface 16.

Furthermore, embodiments may provide the advantage that different from conventional relay architectures where data of one MR 100 can only be routed through its own donor or Un interface 12 to the network (or vice versa), the data of an MR 100 can be routed either via its own Un interface 12, or first to its neighboring MR(s) 200 through the direct relay-relay link using the relay interface 16 and then to the network via another Un interface if necessary. These embodiments may also be referred to as cooperative backhaul embodiments. In other words, the apparatus 10 is operable for relaying data between the mobile transceiver 400 and the mobile communication system 500 using the donor interface 12 or using the relay interface 16. When the relay interface 16 is used, the data can be routed to or through another relay station 200 before being communicated to the mobile transceiver 400 or another network component such as another donor base station transceiver of the other relay station 200. In this embodiment it is assumed that the two relay stations 100, 200 in the train 600 are connected using their respective relay interfaces by a wired connection, e.g. by an optical fiber or an electrical conductor. In other embodiments the relay interface 16 for communicating may be a wireless interface.

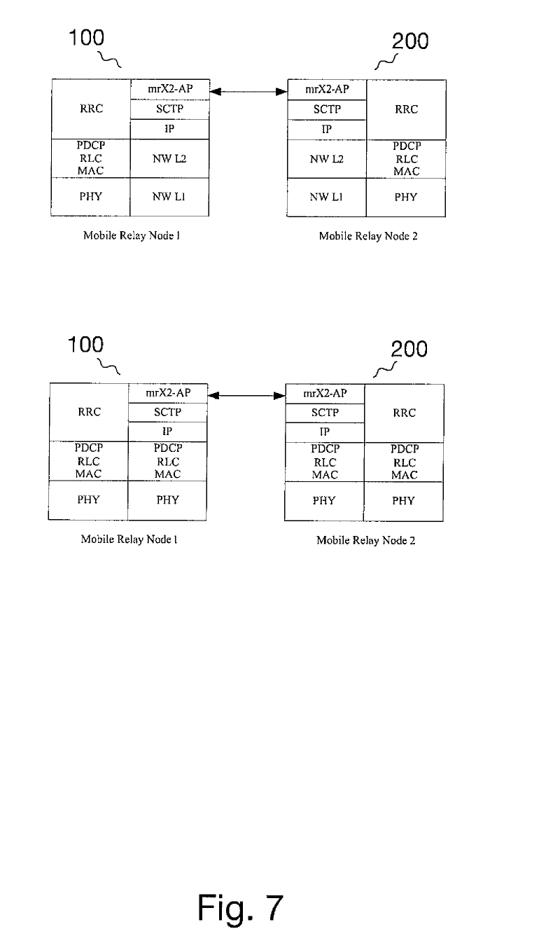

The embodiment uses a direct X2 link between the mobile relays 100, 200. In further embodiments, multiple MRs in one train can be directly interconnected through the relay interface 16, which can also be referred to as mrX2. Moreover, in the present embodiment the relay architecture of alternative 1, i.e. 300-1, is assumed. In other embodiments alternative 2, i.e. 300-2, may be applicable. In embodiments, instead of relying on the Un link, i.e. the donor interface 12, and the GTP-U tunnel between DeNB 300 and relay P/S-GW 310 to carry the X2 traffic, the direct mrX2 link 345 between mobile relays 100, 200 uses a direct network connection between the relays 100, 200, similarly as the X2 between eNBs. SCTP and mrX2-AP protocols may run on it via a local IP tunnel, as indicated by FIG. 7.

FIG. 7 shows protocol stacks for inter- mobile relay communication in embodiments of the mrX2, making use of a mrX2 Application Part (mrX2-AP). The protocol stack of the mobile relay station transceiver 100 is shown on the left, the protocol stack of the other mobile relay station transceiver is shown on the right. Two protocol stacks are shown in FIG. 7, where the protocol stack at the top illustrates a communication through a wired relay interface 16 using network layers NW L1 and NW L2 for communicating. The embodiment displayed at the bottom of FIG. 7 illustrates the communication using a wireless relay interface 16 according to the E-UTRA specifications, i.e. using PDCP, RLC, MAC, and PHY.

The mrX2 interface 16 AP protocol may provide similar functionalities as the conventional X2 interface as defined in 3GPP TS36.423, the functionalities are listed in the table below with corresponding enhancements of at least some embodiments highlighted. The table shows the mapping between mrX2-AP functions and mrX2-AP elementary procedures:

| | |
|---|---|
| Mobility | a) Handover Preparation |
| Management | b) SN Status Transfer |
| | c) UE Context Release |
| | d) Handover Cancel |
| Load | a) Access Link Load Indication |
| Management | b) Access Link Resource Status Reporting Initiation |
| | c) Access Link Resource Status Reporting |
| | d) Backhaul Load Indication |
| | e) Backhaul Resource Status Reporting Initiation |
| | f) Backhaul Resource Status Reporting |
| Reporting of | Error Indication |
| General Error | |
| Situations | |
| Resetting | Reset |
| the X2 | |
| Setting up | X2 Setup |
| the X2 | |
| eNB | a) eNB Configuration Update |
| Configuration | b) Cell Activation |
| Update | c) Backhaul Configuration Update |
| Mobility | Mobility Settings Change |
| Parameters | |
| Management | |
| Mobility | a) Radio Link Failure Indication |
| Robustness | b) Handover Report |
| Optimisation | |
| Energy Saving | a) eNB Configuration Update |
| | b) Cell Activation |

In the embodiment, the apparatus 10 is operable to exchange load information, link status information, or configuration update information with the other relay station transceiver 200 using the relay interface 16. For the load management functionality, apart from the support of information exchange for the access link, the embodiment of the mrX2 interface 16 also supports to exchange load, link status, and configuration update information of backhaul uplink between the mobile relay station transceiver 100 and the donor base station transceiver 300 (relay->DeNB). The backhaul uplink load information exchanged over the mrX2 can be used for load and interference coordination. Moreover, the apparatus 10 is operable to exchange information on measurement reports of the backhaul link between the mobile relay station transceiver 100 and the donor base station transceiver 300, or information on a Transport Network Layer (TNL) association or on IP routing with the other relay station transceiver 200 using the relay interface 16.

The backhaul uplink status information is meant to exchange the backhaul uplink measurement reports. The configuration update information is meant to exchange the backhaul to transfer the updated information for a TNL association and IP routing. Modifications on the X2 interface 16 in embodiments may also include some request, acknowledgement and error signaling for exchanging the above load, status and configuration update information. Thus, the apparatus 10 can be operable to exchange information for load balancing and interference coordination with the other relay station transceiver 200 using the relay interface 16. It may be operable to exchange information on a request, an acknowledgment, or error signaling on load information status information, or configuration update information with the other relay station transceiver 200 using the relay interface 16.

It can be seen from the above description of embodiments that the protocol and functionality of mrX2 can also have similar functionalities as a normal inter-eNB link except some enhancements for backhaul cooperation under high mobility. Particularly, since there is no conventional X2 handover between relay and eNB, the mrX2 in embodiments would not cause ambiguity to the routing of handover messages.

The embodiment described above can also be operable to establish backhaul cooperation between the donor interface 12 and another donor interface of the other relay station transceiver 200. That is to say, the apparatus 10 may take advantage of having two connections to the backhaul, namely a first connection through the donor interface 12 and a second connection through the relay interface 16 and the other relay station transceiver 200.

In some embodiments the apparatus 10 may further comprise means for controlling 18 the relay interface 16 for relaying the data based on a quality of a radio link on the donor interface 12 and based on a quality of a radio link between the other relay station transceiver 200 and another donor base station transceiver 310 of the other relay station transceiver 200. This embodiment would achieve diversity gain from selection combining, i.e. by choosing the better of the two radio links, According to what was described above other combining strategies are also conceivable.

With the introduction of the mrX2 in embodiments, an MR 100 with a poor backhaul link (on the donor interface 12) may route its packets to the other MRs 200 with a better Un link (donor interface of the other mR200) and communicate with its DeNB 300 via the other MR's 200 backhaul link. The X2 inter-relay handover can be also offloaded from the Un interface to the direct link, i.e. to the relay interface 12. Embodiments may therewith enhance the reliability and efficiency of the backhaul.

The embodiment of the mrX2 interface AP protocol may provide the following functions:
UE Mobility Management, responsible for forwarding user plane data, Status Transfer and UE Context Release functions to another MR 200;
Load Management, responsible for exchanging resource status among MRs 100, 200;
General Error Reporting, responsible for exchanging general error situations among MRs 100, 200;
Link Resetting, responsible for resetting the mrX2 interface 16;
Link Setting Up, responsible for exchanging necessary data for the RN 100 for setting up the mrX2 interface 16 and implicitly perform an mrX2 Reset;
MR Configuration Update, responsible for updating of configurations needed for multiple MRs 100, 200 to cooperate correctly over the interface.

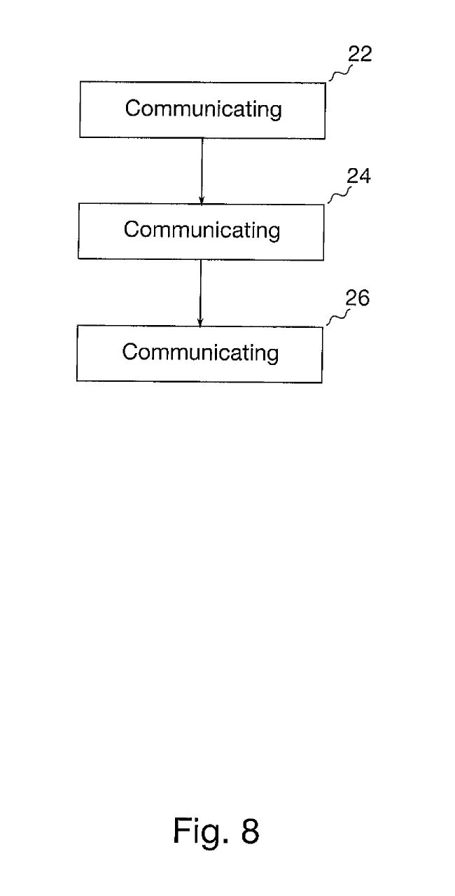

FIG. 8 shows a block diagram of a flow chart of an embodiment of a method for a mobile relay station transceiver 100 in a mobile communication system 500. The method comprises a step of communicating 22 with a donor base station transceiver 300 using a donor interface 12, and a step of communicating 24 with a mobile transceiver 400 using an air interface 14. The method further comprises a step of communicating 26 with another relay station transceiver 200 using a relay interface 16.

Embodiments may further provide a computer program having a program code for performing one of the above methods, when the computer program is executed on a computer or processor.

Embodiments may provide the advantage that a latency of data transmission in the user plane or in the control plane between two mobile relay stations can be reduced. Moreover, the processing load in a multi mobile relay scenario can be decreased, since the inter relay communication can at least partly be carried out using the direct interface instead of using two Un interfaces. Moreover, the number of SCTP connections may be reduced, which may equal the number of neighboring eNBs and RNs in the conventional approach and may be reduced to one connection to the MME, and less than two to neighboring RNs (equal to number of neighboring RNs). Moreover, through the cooperative backhaul approaches advantages with respect to latency, efficiency, service availability and capacity may be achieved.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods or (field) programmable logic arrays ((F)PLAs) or (field) programmable gate arrays ((F)PGAs), programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Functional blocks denoted as “means for . . . ” (performing a certain function) shall be understood as functional blocks comprising circuitry that is adapted for performing or to perform a certain function, respectively. Hence, a “means for s.th.” may as well be understood as a “means being adapted or suited for s.th.”. A means being adapted for performing a certain function does, hence, not imply that such means necessarily is performing said function (at a given time instant).

The functions of the various elements shown in the Figures, including any functional blocks labeled as “means”, “means for controlling”, etc., may be provided through the use of dedicated hardware, such as “a controller”, etc. as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. An apparatus for a mobile relay station transceiver in a mobile communication system, the apparatus comprising
a donor interface operable to communicate with a donor base station transceiver;
an air interface operable to communicate with a mobile transceiver; and
a relay interface operable to communicate with another relay station transceiver.

2. The apparatus of claim 1, further comprising means for controlling a mobility of the mobile transceiver, wherein the means for controlling is operable to control the relay interface such that a control signal relating to a mobility of the mobile transceiver between the mobile relay station transceiver and the other relay station transceiver is exchanged using the relay interface.

3. The apparatus of claim 1, wherein the air interface generates a first coverage area for the mobile transceiver and wherein the other relay station transceiver generates a second coverage area for the mobile transceiver, wherein the first coverage area and the second coverage area are adjacent to each other, wherein the relay interface for communicating is operable to communicate with the other relay station transceiver when the mobile transceiver moves between the first and the second coverage areas.

4. The apparatus of claim 1, wherein the relay interface for communicating is a wireless interface.

5. The apparatus of claim 1, further operable for relaying data between the mobile transceiver and the mobile communication system using the donor interface or using the relay interface.

6. The apparatus of claim 5, further comprising means for controlling the relay interface for relaying the data based on a quality of a radio link on the donor interface and based on a quality of a radio link between the other relay station transceiver and another donor base station transceiver of the other relay station transceiver.

7. The apparatus of claim 1, being operable to exchange load information, link status information, or configuration update information with the other relay station transceiver using the relay interface

8. The apparatus of claim 1, being operable to exchange information on measurement reports of a backhaul link between the mobile relay station transceiver and the donor base station transceiver or information on a transport network layer association or on internet protocol routing with the other relay station transceiver using the relay interface.

9. The apparatus of claim 1, being operable to exchange information for load balancing and interference coordination with the other relay station transceiver using the relay interface.

10. The apparatus of claim 1, being operable to exchange information on a request, an acknowledgment, or error signaling on load information status information, or configuration update information with the other relay station transceiver using the relay interface.

11. The apparatus of claim 1, being operable to establish a backhaul cooperation between the donor interface and another donor interface of the other relay station transceiver.

12. A system comprising a first mobile relay station transceiver with an apparatus and a second mobile relay station transceiver with another apparatus according to claim 1, the first and the second mobile relay station transceivers being coupled through their relay interfaces for communicating.

13. Means of mass transportation with the system of claim 12.

14. A method for a mobile relay station transceiver in a mobile communication system, the method comprising communicating with a donor base station transceiver using a donor interface;
communicating with a mobile transceiver using an air interface; and
communicating with another relay station transceiver using a relay interface.

15. A computer program having a program code for performing the method of claim 14, when the computer program is executed on a computer or processor.
